(19) United States
(12) Patent Application Publication
(10) Pub. No.: US 2026/0113759 A1
(43) Pub. Date: Apr. 23, 2026

(54) SIDELINK CARRIERS FOR CARRIER AGGREGATION

(71) Applicant: Apple Inc., Cupertino, CA (US)

(72) Inventors: Zhibin Wu, Los Altos, CA (US); Alexander Sirotkin, Hod Hasharon (IL); Chunxuan Ye, San Diego, CA (US); Fangli Xu, Beijing (CN); Haijing Hu, Los Gatos, CA (US); Naveen Kumar R. Palle Venkata, San Diego, CA (US); Peng Cheng, Beijing (CN); Ralf Rossbach, Munich (DE); Yuqin Chen, Beijing (CN)

(21) Appl. No.: 19/111,520

(22) PCT Filed: Sep. 13, 2023
(86) PCT No.: PCT/US23/32605

§ 371 Date: Mar. 13, 2025

Related U.S. Application Data
(60) Provisional application No. 63/407,474, filed on Sep. 16, 2022.

(51) Int. Cl. H04W 72/25

(52) U.S. Cl. CPC H04W 72/25

(57) ABSTRACT

The disclosure relates to a method to be performed by a user equipment. The method involves: determining a primary component carrier (PCC) for use in carrier aggregation over a sidelink interface with a second UE, where the component carrier is used at least for control signaling; and communicating with the second UE via the primary component carrier.

### CROSS-REFERENCE TO RELATED APPLICATIONS

The present application claims priority to U.S. Provisional Application No. 63/407,474, filed on Sep. 16, 2022, titled “Sidelink Carriers for Carrier Aggregation,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

This disclosure describes sidelink carrier aggregation in a new generation wireless communication system (e.g., an NR system or a later generation system). In some implementations, UEs that use a sidelink interface can be configured with a sidelink carrier aggregation configuration. The sidelink carrier aggregation configuration includes an indication of a sidelink primary component carrier (PCC) and one or more secondary component carriers (SCCs). The sidelink PCC serves as an anchor carrier that can be used to carry sidelink control signaling. The one or more configured SCCs can be selectively activated and deactivated by the UEs. Thus, a particular SCC can be used by the UEs only if it is activated (and can no longer be used if it is deactivated). Among other benefits, the selective activation of SCCs achieves power savings for the UEs by enabling the UEs to monitor only the activated SCCs.

In accordance with one aspect of the present disclosure, a method to be performed by a first user equipment (UE) is disclosed. The method involves determining a primary component carrier (PCC) for use in carrier aggregation over a sidelink interface with a second UE, where the PCC is used at least for control signaling; and communicating with the second UE via the PCC.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the method further involving receiving, from a base station, a sidelink carrier aggregation configuration that includes an indication of the PCC.

In some implementations, the sidelink carrier aggregation configuration further includes a configured component carrier set.

In some implementations, communicating with the second UE via the PCC involves initiating a capability exchange procedure with the second UE to determine that the second UE is capable of sidelink carrier aggregation.

In some implementations, the method further involving generating a candidate secondary component carrier (SCC) set that includes one or more SCCs selected from a configured component carrier set for use in the sidelink interface with the second UE; and sending the second UE a reconfiguration message that includes the candidate SCC set.

In some implementations, sending the second UE the reconfiguration message involves sending the second UE the reconfiguration message via the PCC.

In some implementations, the method further involving receiving, from the second UE, a response message accepting or rejecting the candidate SCC set.

In some implementations, the response message rejects the candidate SCC set, and the response message further include a rejection cause.

In some implementations, the candidate SCC is a first candidate SCC set and the reconfiguration message is a first reconfiguration message, and where the method further involves: receiving, from the second UE, a second reconfiguration message that includes a second candidate SCC set; and determining whether to process the first candidate SCC set or the second candidate SCC set.

In some implementations, determining whether to process the first candidate SCC set or the second candidate SCC set is based on a comparison of a first source ID of the first UE and a second source ID of the second UE.

In some implementations, determining whether to process the first candidate SCC set or the second candidate SCC set is based on a comparison of: (i) a first tie-breaker value included in the first reconfiguration message, and (ii) a second tie-breaker value included in the second reconfiguration message.

In some implementations, the first and second tie-breaker values are based on a randomly selected number or a timestamp.

In some implementations, the method further involving in response to determining to process the second candidate SCC set, sending a response message to the second UE accepting the second candidate SCC set.

In some implementations, the method further involving in response to determining to process the first candidate SCC set, receiving a response message from the second UE accepting the first candidate SCC set.

In some implementations, the method further involving generating a SCC message for activating or deactivating a first SCC in the candidate SCC set; and sending the SCC message to the second UE.

In some implementations, generating the SCC message is performed responsive to determining that the first UE is a primary UE and the second UE is a secondary UE.

In some implementations, the method further involving starting a timer after sending the SCC message to the second UE; receiving a response from the second UE within a pre-configured timer period; and responsive to receiving the response, stopping the timer.

In some implementations, the SCC message further includes a tie-breaker value.

The details of one or more implementations of the subject matter of this specification are set forth in the Detailed Description, the accompanying drawings, and the claims. Other features, aspects, and advantages of the subject matter will become apparent from the description, the claims, and the accompanying drawings.

### BRIEF DESCRIPTION OF THE FIGURES

FIG. 1 illustrates an example communication system that includes sidelink communications, according to some implementations.

FIG. 2 illustrates an example messaging flow for sidelink secondary component carrier (SCC) configuration between two user equipment (UEs), according to some implementations.

FIG. 3 illustrates another example messaging flow for sidelink SCC configuration between two UEs, according to some implementations.

FIG. 4 illustrates an example sidelink MAC CE for activating or deactivating a SCC, according to some implementations.

FIG. 5A illustrates an example sidelink SCC activation/deactivation MAC CE request format, according to some implementations.

FIG. 5B illustrates an example sidelink SCC activation/deactivation MAC CE response format, according to some implementations

FIG. 6 illustrates an example method, according to some implementations.

FIG. 7 illustrates a user equipment (UE), according to some implementations.

FIG. 8 illustrates an access node, according to some implementations.

Like reference numbers and designations in the various drawings indicate like elements.

### DETAILED DESCRIPTION

One of the areas for study and development in Release 18 of the Third Generation Partnership Project (3GPP) technical standards is sidelink carrier aggregation in new radio (NR) systems. Legacy carrier aggregation techniques may have deficiencies with respect to carrier aggregation for sidelink operations in NR systems. Therefore, sidelink carrier aggregation procedures for NR need to be developed.

This disclosure describes sidelink carrier aggregation in a new generation wireless communication system (e.g., an NR system or a later generation system). In some implementations, UEs that use a sidelink interface can be configured with a sidelink carrier aggregation configuration. The sidelink carrier aggregation configuration includes an indication of a sidelink primary component carrier (PCC) and one or more secondary component carriers (SCCs). The sidelink PCC serves as an anchor carrier that can be used to carry sidelink control signaling. The one or more configured SCCs can be selectively activated and deactivated by the UEs. Thus, a particular SCC can be used by the UEs only if it is activated (and can no longer be used if it is deactivated). Among other benefits, the selective activation of SCCs achieves power savings for the UEs by enabling the UEs to monitor only the activated SCCs.

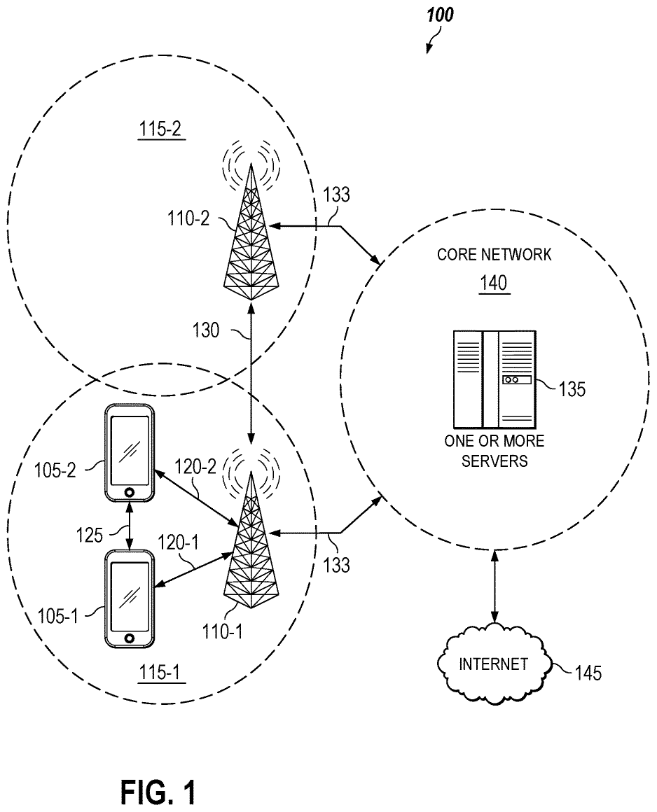

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi networks, and the like. Furthermore, other types of communication standards are possible, including future 3GPP systems (e.g., Sixth Generation (6G)), IEEE 802.16 protocols (e.g., WMAN, WiMAX, etc.), or the like. While aspects may be described herein using terminology commonly associated with 5G NR, aspects of the present disclosure can be applied to other systems, such as 4G and/or systems subsequent to 5G (e.g., 6G).

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communications protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers (SL-RBs) may be established on the sidelink 125. The sidelink radio bearers can include signaling radio bearers (SL-SRB) and/or data radio bearers (SL-DRB). The signaling radio bearers may have different types including SL-SRB0, SL-SRB1, SL-SRB2, SL-SRB3, and SL-SRB4.

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and road side units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 105 are configured to use sidelink carrier aggregation in sidelink 125. In one example, the UEs 105 receive a sidelink carrier aggregation configuration from a base station (e.g., the base station 110), perhaps via an RRC message over Uu (e.g., links 120). The sidelink carrier aggregation configuration can include a component carrier set to be used for carrier aggregation services in broadcast/groupcast and/or unicast. By providing the component carrier set, the base station(s) can have control over carrier usage in the sidelink 125.

In some implementations, the sidelink carrier aggregation configuration also includes a PCC/SCC configuration that specifies a PCC and a set of one or more SCCs. This can be indicated explicitly by labeling one of the carriers as a primary carrier in the sidelink carrier configuration. Alternatively, this can be implicitly indicated by assuming that the first carrier in a carrier set list/array is the primary carrier. Unlike CA over Uu interface where UL CA and DL CA configurations are different, the PCC/SCC configuration used in sidelink can be bidirectional, which means that the configuration is used in both directions of sidelink communication between the UEs 105. Thus, there is no clear need for unidirectional configurations for each direction of the SL communication between the two UEs 105. However, without loss of generality, the methods disclosed herein also encompass the case where different SCC sets are used in different directions between UEs 105. In some examples, the UEs 105 use the PCC/SCC configuration in sidelink unicast. Specifically, when operating in sidelink unicast, the UEs 105 use the PCC as the primary carrier, and use the set of SCCs, or a subset thereof, as secondary carriers. As explained in more detail below, the specific set of SCCs used by the UEs 105 can be reconfigured by the UEs 105, perhaps using PC5-RRC signaling. Thus, the set of SCCs that is ultimately used by the UEs 105 may not be identical to the set included in the sidelink carrier aggregation configuration.

In some implementations, the PCC can be used for carrying one or more types of information between the UEs 105. First, the PCC can be used for carrying PC5-RRC messages, such as messages for initial and/or essential configuration of the sidelink 125. Second, the PCC can be used for carrying PC5 signaling protocol stack (PC5-S) messages, such as Direct Communication Request (DCR) messages, which can be used to drive PC5 link establishment in upper layers (e.g., a V2X layer, a ProSe layer, etc.). Third, the PCC can be used for carrying synchronization signals, such as sidelink synchronization signal (SLSS) and sidelink synchronization signal block (S-SSB). Fourth, the PCC can be used for cross-carrier sidelink scheduling. Fifth, the PCC can be used for carrying sidelink Medium Access Control (MAC) control elements (CEs), such as sidelink MAC CEs for activating/deactivating a SCC, which are described in more detail below. Note that it is also possible that PCC is only used to carry some PC5-RRC messages, but not all of them. For example, after the capability exchange between two SL UEs, via RRCReconfigurationSidelink procedure, the UEs can negotiate to move the ensuing RRC signaling in SL-SRB3 to use both PCC and SCC, thereby gaining the throughput/reliability benefits of SL carrier aggregation. This can be also applicable to some PC5-S signaling in SL-SRB2.

Sixth, the PCC can be used for carrying Hybrid Automatic Repeat Request (HARQ) feedback, as there is no need to send HARQ feedback in each component carrier. There are at least two reasons why the PCC can be used to carry HARQ feedback. One, transmitting sidelink HARQ feedback via the PCC may be beneficial in many scenarios, such as when the peer UE receiving the feedback has power/radio frequency (RF) chain restrictions, or when the PCC is at a lower frequency with better propagation than other component carriers. Two, the resource pool on the SCC(s) may be configured without PSFCH resources.

In some implementations, an activated SCC can be used for carrying: user plane data, HARQ feedback, sidelink channel state information (CSI) reports, PC5-RRC for SCC-specific configurations (if such configurations are supported), and/or for SLSS.

In some implementations, the UEs 105 can reconfigure, add, or remove SCCs from the set of SCCs, perhaps using PC5-RRC signaling. More specifically, after the UEs 105 receive the sidelink carrier aggregation configuration, the UEs communicate to determine the other UE's sidelink carrier aggregation capability. After each UE determines the other UE's capability, one of the UEs 105 can initiate a SCC set configuration procedure. The initiating UE generates a new candidate SCC set, and provides the candidate set to the peer UE. Once the peer UE receives the candidate SCC set, the peer UE determines whether to accept or reject the new set, and provides a response message to the initiating UE indicating whether the new set is accepted or rejected. If the response message is a reject message, the message can include a reason or cause for the rejection. As an example, the cause for rejection can be an inability of the UE to comply with the request. which means the UE's capability does not support to use the SCC set provided by the initiating UE. As another example, the cause for rejection can be a rejection of the proposed SCC set. Here, the peer UE's capability can support the configuration, but the peer UE has an alternative proposal and determines to choose the alternative configuration. Also, the peer UE may know that one of the component carriers in the proposed SCC set has bad performance (e.g., due to bad radio conditions), and therefore, may determine to select a different CC instead.

Note that this procedure is different from Uu because there is no master node in sidelink communication. Therefore, it is possible for a UE to reject the peer UE's candidate SCC set, whereas in Uu, a UE cannot reject a network's choice of a candidate component carrier list.

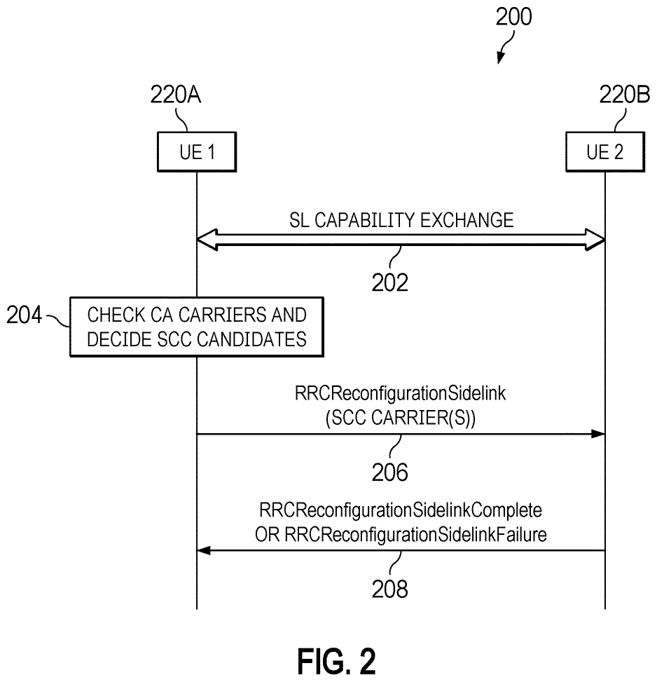

FIG. 2 illustrates an example messaging flow 200 for sidelink SCC configuration between two UEs, according to some implementations. The messaging flow 200 can be used for the reconfiguration, addition, and/or removal of sidelink SCCs, perhaps using PC5-RRC signaling. In this example, the two UEs, UE 1 and UE 2 (also labelled as UE 220A, UE 220B), are coupled via a sidelink interface.

At 202, the UEs 220A, 220B exchange sidelink capability information. The sidelink capability information includes information that is implicitly or explicitly indicative of whether the UEs support sidelink carrier aggregation. As an example, the indication can be part of SL capability signaling IE, which may include: (i) an IE named “SL-carrierAggregation-r18,” which explicitly indicates whether the UE supports CA or not, or (ii) CA bandwidth class parameters included in “supportBandCombination-SL”, which implicitly indicate that sidelink carrier aggregation is supported by the UE.

After each UE determines the other UE's sidelink carrier aggregation capability, one of the UEs can initiate the configuration of a candidate SCC set. At 204, the UE 220A determines to initiate the configuration of a candidate SCC set. The UE 220A then checks the configured carrier aggregation carriers (e.g., included in the sidelink carrier aggregation configuration) and selects one or more SCC candidates to include in the candidate SCC set, perhaps based on one or more factors. In some examples, the UE can select the candidate SCC set based on SL CA capability of both UEs (e.g. which SL CA carriers are supported), how many CCs are needed for the traffic throughput, measurement values associated with the CCs, and/or the corresponding QoS requirements to be supported in sidelink.

At 206, the UE 220A sends the UE 220B a message (e.g., RRC Reconfiguration Sidelink) that includes the candidate SCC set. At 208, the UE 220B sends the UE 220B either an accept message (e.g., RRC Reconfiguration Sidelink Complete) to accept the candidate set or a reject message (e.g., RRC Reconfiguration Sidelink Failure) to reject the candidate set. In some implementations, once the SCC set is determined, the RRC Reconfiguration Sidelink procedure can be also used to further determine for one or more SL-RB, whether carrier aggregation is used or not. And if it used, which carriers in the SCC set are chosen for CA between those two UEs, perhaps on an SL-RB by SL-RB basis. For example, for SL-SRBs used to carry PC5-S or PC5-RRC signaling, the PCC and SCC combination is also feasible to improve the throughout and reliability of control plane procedures in the sidelink interface. The initiating UE of the RRC Reconfiguration Sidelink message can propose to supplement one or more additional chosen SCC(s) for a SL-SRB “x,” and the responding UE can acknowledge the configuration by sending a RRCReconfigurationCompleteSidelink message. The additional SCC(s) for the SL-SRB can be chosen (e.g., from configured carrier aggregation carriers or from the SCC set) based on certain criteria, e.g., based on CBR (channel busy ratio).

In some scenarios, before the completion of a sidelink SCC configuration procedure that has been initiated by one UE, it is possible that the same procedure may be initiated by the other UE. This may create a conflict if the SCC sets are configured to be bi-directional. A conflict may occur when both UEs initiate the sidelink SCC configuration procedure simultaneously. In order to avoid this conflict, the UEs 105 may be configured with a mechanism for determining which procedure shall be processed and which shall be abandoned. In one example, the mechanism is based on which UE's source Layer 2 ID (SRC L2 ID) is greater (or less) than the other. This mechanism favors one UE such that the selection of which UE's procedure to maintain is static. In another example, the mechanism is based on a dynamically chosen “tie-breaker” that is included in the sidelink reconfiguration message. The tie-breaker can be based on a random selected number or a timestamp associated with the sidelink reconfiguration message.

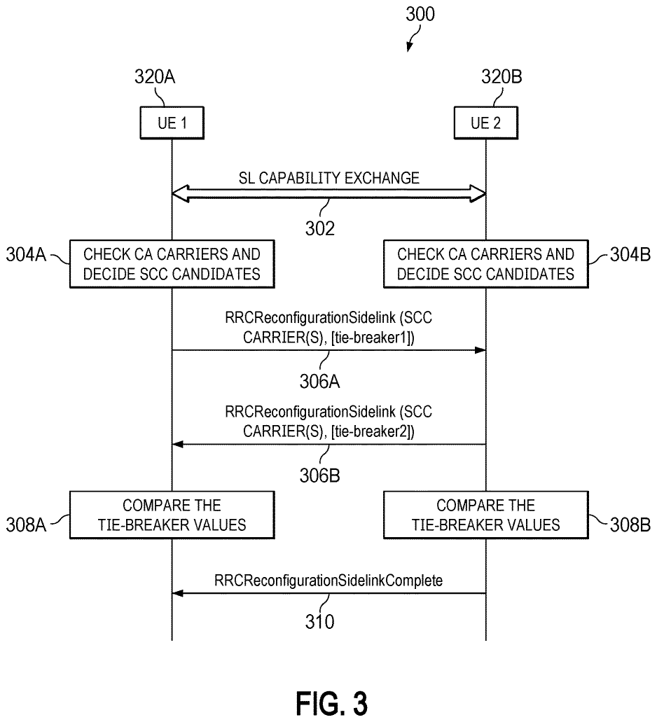

FIG. 3 illustrates another example messaging flow 300 for sidelink SCC configuration between two UEs, according to some implementations. The example messaging flow 300 illustrates a scenario where UE 320A, UE 320B simultaneously initiate a sidelink SCC configuration procedure.

At 302, UE 320A, UE 320B exchange sidelink capability information. The sidelink capability information includes information indicative of whether the UEs support sidelink carrier aggregation. After each UE determines the other UE's sidelink carrier aggregation capability, at least one of the UEs can initiate the configuration of a candidate set of SCCs. In this example, both UEs determine to initiate the configuration of a candidate set of SCCs. As shown in FIG. 3, both UEs check the configured carrier aggregation carriers and select one or more SCC candidates at 304A, 304B.

At 306A, UE 320A sends UE 320B a message (e.g., RRC Reconfiguration Sidelink) that includes the candidate SCC set selected by UE 320A. The message also includes a first tie-breaker value (e.g., a randomly selected number or a timestamp). At 306B, UE 320B also sends UE 320A a message that includes the candidate SCC set selected by UE 320B. The message also includes a second tie-breaker value (e.g., a randomly selected number or a timestamp). Once each UE receives the other UE's message, the UEs 320A and UE 320B determine that a conflict has arisen, and responsively perform mechanism for determining which candidate SCC set is selected and which candidate SCC set is abandoned. In this example, the mechanism is a dynamic mechanism. Accordingly, the UEs 320A and UE 320B compare the first tie-breaker value to the second tie-breaker value at 308A, 308B respectively. When the first tie-breaker value “wins,” the first candidate SCC set generated by UE 320A is to be processed by the UE 320B, and when the second tie-breaker value “wins,” the second candidate SCC set generated by UE 320B is to be processed by the UE 320A. In this example, the UEs determine based on the comparison to select the first candidate SCC set generated by UE 320A. Accordingly, at 310, UE 320B sends UE 320A an accept message (e.g., RRC Reconfiguration Sidelink Complete).

In some implementations, the RRC signaling that configures the SCCs can also be used to activate an SCC by default as the initial condition. That is, the completion of the configuration of SCC set is also places the one or more SCCs in the set in an “ACTIVE” state. Thus, the UE does not need to send another explicit signaling to activate those CCs in the SCC set.

After the SCC set is selected, one or more of the UEs 105 can be configured to selectively activate or deactivate SCCs. In some implementations, the UEs 105 may be configured to use one of one or more procedures for activating/deactivating a SCC.

In a first procedure, a UE can use a sidelink MAC CE to activate or deactivate a SCC. In an example, the MAC CE can include 8 bits, and therefore, up to 8 sidelink SCCs can be activated/deactivated using a single MAC CE. Each bit, Ci, corresponds to an index of in the SCC set: “0” means the SCC at that index is deactivated; “1” means that the SCC at that index is activated.

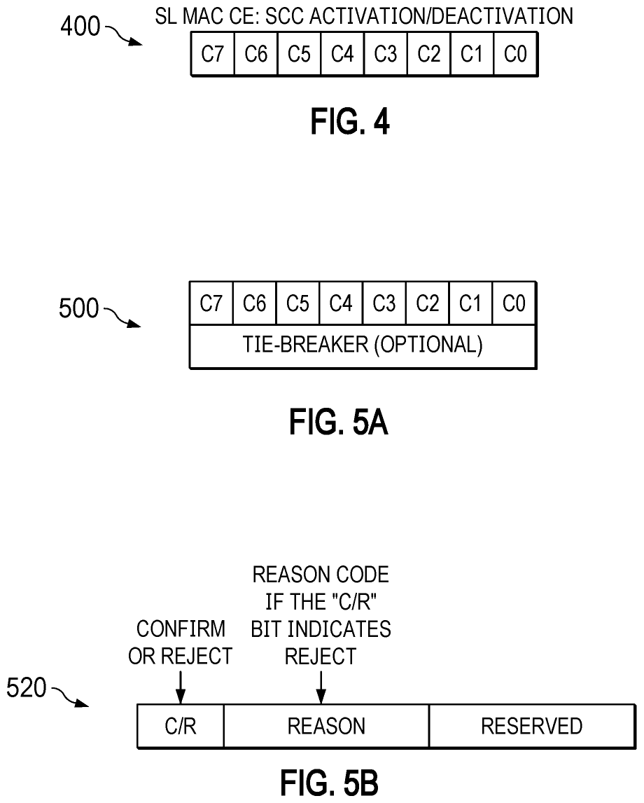

FIG. 4 illustrates an example sidelink MAC CE 400 for activating or deactivating a SCC, according to some implementations. As shown in FIG. 4, the MAC CE 400 includes 8 bits, and therefore, up to 8 sidelink SCCs can be activated/deactivated using a single MAC CE. Each bit, Ci, corresponds to an index of in the SCC set: “0” means the SCC at that index is deactivated; “1” means that the SCC at that index is activated.

Note that if the SCC set is only for directional usage (e.g., TX UE to RX UE), then only the TX UE is able to send activation/deactivation signaling to the peer UE (RX UE), and there will be no conflict in this case. However, a conflict may arise if both UEs can issue sidelink MAC CE commands to the other UE for the case when SCC set is bidirectional. That is, in the case of bi-directional SCC, the two UEs can issue activation and/or deactivation commands that may be conflicting.

In some implementations, a “primary” UE is selected such that only one of the UEs is permitted to activate/deactivate SCCs. In these implementations, only the “primary” UE can issue sidelink MAC CE commands. The “primary-secondary” relationship can be determined based on a predetermined rule. In a first example, the primary UE is the UE that initiates the SCC carrier configuration in the PC5-RRC process. In a second example, the primary UE is the UE that initiates a PC5-S “Direct Communication Request” message in the link establishment procedure or initiates the capability exchange procedure in PC5-RRC protocol. In a third example, the primary UE is the UE with the greater L2 Src ID (or alternatively the UE with the lower L2 Src ID).

In a fourth example, the primary UE is the UE with the stricter performance requirements. The performance requirements can be determined based on UE's traffic load or QoS requirements of the traffic. As an example, consider a scenario where one UE (UE A) has more traffic that needs to be delivered to UE B than what needs to be delivered from UE B to UE A. In this scenario, UE A has more strict performance requirements. In another example, if the reliability for UE'A's traffic is 99.99%, but the reliability requirement for UE-B's traffic is only 99%, then UE A has stricter performance requirements. In a fifth example, the primary UE is selected based on a priority value for inter-UE coordination information, where the priority value can be set based on a set of conditions.

In some implementations, the primary role can be “shared” among the peer UEs. For example, a “timeshare” can be implemented such that the UEs alternate the assumption of the primary role, perhaps based on a pre-configured cycle. The cycle length can be configured in Uu RRC or PC5-RRC.

In a second procedure, the SCC activation/deactivation is based on a request-response negotiation between the two UEs. In this procedure, a first UE sends a MAC CE “SCC Activation/Deactivation Request” to a second UE and starts a timer. The second UE is configured to return a confirmation/reject MAC CE as a response within a pre-configured timer period. The first UE is configured to not trigger a new request as long as the timer is running, and is configured to stop the timer if a response is received. In this way, both UEs can still share the decision process without introducing a “primary/secondary” role among the two UEs. In some examples, a “tie-breaker” can be included in the “SCC Activation/Deactivation Request” in order to resolve a conflict in scenarios where both UE send a “SCC Activation/Deactivation Request.”

FIG. 5A illustrates an example sidelink SCC activation/deactivation MAC CE request format 500, according to some implementations. As shown in FIG. 5A, the MAC CE 500 includes 8 bits, and therefore, up to 8 sidelink SCCs can be activated/deactivated using a single MAC CE. Each bit, Ci, corresponds to an index of in the SCC set: “0” means the SCC at that index is deactivated; “1” means that the SCC at that index is activated. As also shown in FIG. 5, the MAC CE 500 can include up to 8 bits for a “tie-breaker”value.

FIG. 5B illustrates an example sidelink SCC activation/deactivation MAC CE response format 520, according to some implementations. As shown in FIG. 5B, the MAC CE 520 can include one or more bits that indicate whether it is an accept or reject message. In scenarios where the C/R bit indicates reject, the MAC CE 520 can additionally include one or more bits for a “reject reason”code.

In some implementations, the UEs 105 may be configured to perform maintenance for SCCs. Different component carriers may experience similar path-loss conditions between two sidelink UEs, but a sidelink channel could be commonly shared by many sidelink UEs in proximity of one another, so it is possible to have fluctuation of radio conditions in different carriers. Therefore, in some implementations, per-CC measurements reporting is supported in sidelink carrier aggregation. In these implementations, a measurement object (MO) structure can be generated for one or more carriers in order to achieve the per-CC measurements.

The measurement of a CC is to evaluate a signal quality of a specific component carrier (CC) among the CC sets used in sidelink, perhaps by comparing the measured value to a preconfigured threshold. The SCC measurements can be based on measurement threshold or reporting (e.g., Channel Busy Ratio [CBR] or sidelink Reference Signal Received Power [RSRP]). For active SCCs, the measurement can be performed based on SL-RSRP. For deactivated SCCs, the measurement can be done performed on CBR. In some examples, the measurements or measurement reports can be event triggered. For example, a trigger event may be if the signal quality is below a threshold. In this example, an event-triggered measurement report is sent to the peer UE. The report enables the peer UE to determine which CCs to activate or deactivate (if any).

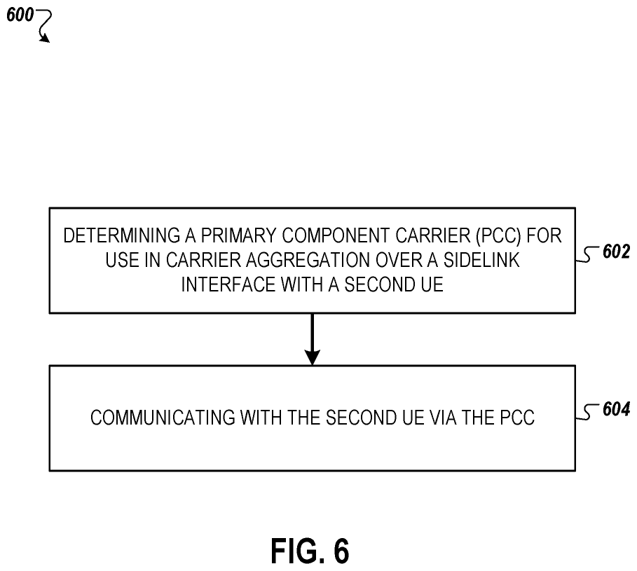

FIG. 6 illustrates a flowchart of an example method 600, according to some implementations. For clarity of presentation, the description that follows generally describes method 600 in the context of the other figures in this description. For example, method 600 can be performed by UEs 105 of FIG. 1. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order. In some implementations, method 600 is performed by a first UE.

At 602, method 600 involves determining a primary component carrier (PCC) for use in carrier aggregation over a sidelink interface with a second UE, where the PCC is used at least for control signaling.

At 604, method 600 involves communicating with the second UE via the primary component carrier.

In some implementations, the method further involving receiving, from a base station, a sidelink carrier aggregation configuration that includes an indication of the PCC.

In some implementations, the sidelink carrier aggregation configuration further includes a configured component carrier set.

In some implementations, communicating with the second UE via the PCC involves initiating a capability exchange procedure with the second UE to determine that the second UE is capable of sidelink carrier aggregation.

In some implementations, the method further involving generating a candidate secondary component carrier (SCC) set that includes one or more SCCs selected from a configured component carrier set for use in the sidelink interface with the second UE; and sending the second UE a reconfiguration message that includes the candidate SCC set.

In some implementations, sending the second UE the reconfiguration message involves sending the second UE the reconfiguration message via the PCC.

In some implementations, the method further involving receiving, from the second UE, a response message accepting or rejecting the candidate SCC set.

In some implementations, the response message rejects the candidate SCC set, and the response message further include a rejection cause.

In some implementations, the candidate SCC is a first candidate SCC set and the reconfiguration message is a first reconfiguration message, and where the method further involves: receiving, from the second UE, a second reconfiguration message that includes a second candidate SCC set; and determining whether to process the first candidate SCC set or the second candidate SCC set.

In some implementations, determining whether to process the first candidate SCC set or the second candidate SCC set is based on a comparison of a first source ID of the first UE and a second source ID of the second UE.

In some implementations, determining whether to process the first candidate SCC set or the second candidate SCC set is based on a comparison of: (i) a first tie-breaker value included in the first reconfiguration message, and (ii) a second tie-breaker value included in the second reconfiguration message.

In some implementations, the first and second tie-breaker values are based on a randomly selected number or a timestamp.

In some implementations, the method further involving in response to determining to process the second candidate SCC set, sending a response message to the second UE accepting the second candidate SCC set.

In some implementations, the method further involving in response to determining to process the first candidate SCC set, receiving a response message from the second UE accepting the first candidate SCC set.

In some implementations, the method further involving generating a SCC message for activating or deactivating a first SCC in the candidate SCC set; and sending the SCC message to the second UE.

In some implementations, generating the SCC message is performed responsive to determining that the first UE is a primary UE and the second UE is a secondary UE.

In some implementations, the method further involving starting a timer after sending the SCC message to the second UE; receiving a response from the second UE within a pre-configured timer period; and responsive to receiving the response, stopping the timer.

In some implementations, the SCC message further includes a tie-breaker value.

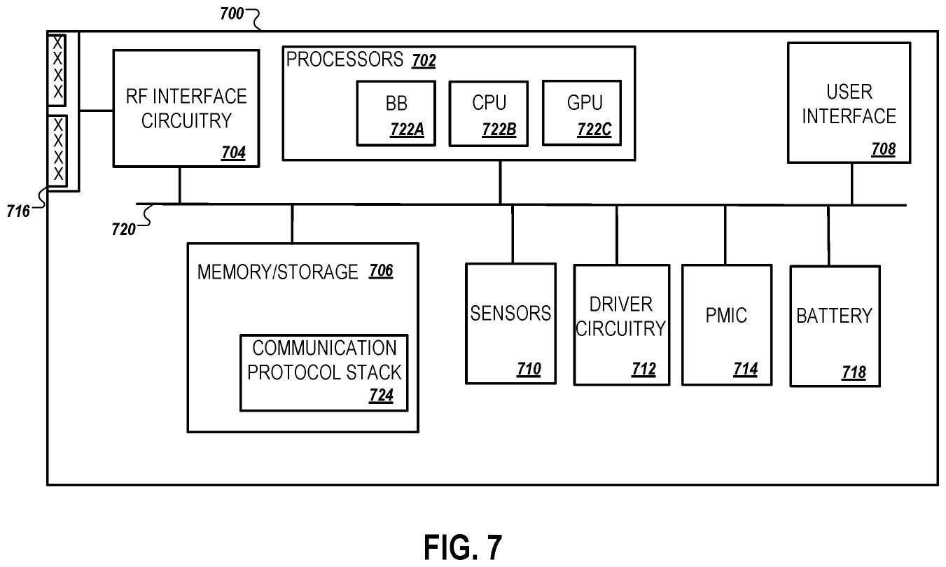

FIG. 7 illustrates a UE 700, according to some implementations. The UE 700 may be similar to and substantially interchangeable with UE 105 of FIG. 1.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, one or more antennas 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM”in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716. In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensors 710 and control and allow access to sensors 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

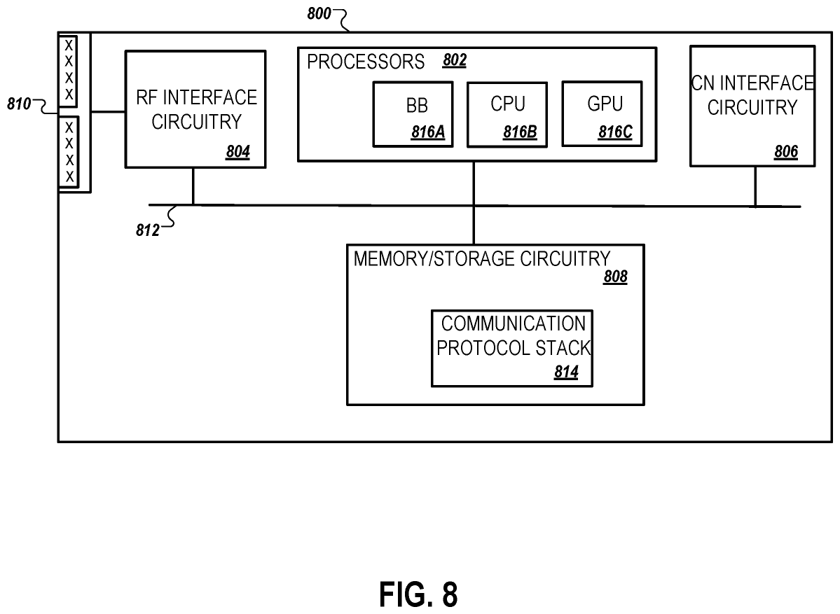

FIG. 8 illustrates an access node 800 (e.g., a base station or gNB), according to some implementations. The access node 800 may be similar to and substantially interchangeable with base station 110 of FIG. 1. The access node 800 may include processors 802, RF interface circuitry 804, core network (CN) interface circuitry 806, memory/storage circuitry 808, and one or more antennas 810.

The components of the access node 800 may be coupled with various other components over one or more interconnects 812. The processors 802, RF interface circuitry 804, memory/storage circuitry 808 (including communication protocol stack 814), one or more antennas 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,”and the like.

Various components may be described as performing a task or tasks, for convenience in the description. Such descriptions should be interpreted as including the phrase “configured to.” Reciting a component that is configured to perform one or more tasks is expressly intended not to invoke 35 U.S. C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 includes one or more processors of a first user equipment (UE), the one or more processors configured to cause the first UE to perform operations including: determining a primary component carrier (PCC) for use in carrier aggregation over a sidelink interface with a second UE, where the PCC is used at least for control signaling; and communicating with the second UE via the primary component carrier.

Example 2 is the one or one or more processors of Example 1, the operations further including: receiving, from a base station, a sidelink carrier aggregation configuration that includes an indication of the PCC.

Example 3 is the one or more processors of Example 2, where the sidelink carrier aggregation configuration further includes a configured component carrier set.

Example 4 is the one or more processors of any of Examples 1-3, where communicating with the second UE via the PCC involves initiating a capability exchange procedure with the second UE to determine that the second UE is capable of sidelink carrier aggregation.

Example 5 is the one or more processors of any of Examples 1-4, the operations further including: generating a candidate secondary component carrier (SCC) set that includes one or more SCCs selected from a configured component carrier set for use in the sidelink interface with the second UE; and sending the second UE a reconfiguration message that includes the candidate SCC set.

Example 6 is the one or more processors of Example 5, where sending the second UE the reconfiguration message includes sending the second UE the reconfiguration message via the PCC.

Example 7 is the one or more processors of Example 5, the operations further including: receiving, from the second UE, a response message accepting or rejecting the candidate SCC set.

Example 8 is the one or more processors of Example 7, where the response message rejects the candidate SCC set, and where the response message further comprises a rejection cause.

Example 9 is the one or more processors of Example 5, where the candidate SCC is a first candidate SCC set and the reconfiguration message is a first reconfiguration message, and the operations further including: receiving, from the second UE, a second reconfiguration message that includes a second candidate SCC set; and determining whether to process the first candidate SCC set or the second candidate SCC set.

Example 10 is the one or more processors of Example 9, where determining whether to process the first candidate SCC set or the second candidate SCC set is based on a comparison of a first source ID of the first UE and a second source ID of the second UE.

Example 11 is the one or more processors of Example 9, where determining whether to process the first candidate SCC set or the second candidate SCC set is based on a comparison of: (i) a first tie-breaker value included in the first reconfiguration message, and (ii) a second tie-breaker value included in the second reconfiguration message.

Example 12 is the one or more processors of Example 11, where the first and second tie-breaker values are based on a randomly selected number or a timestamp.

Example 13 is the one or more processors of Example 9, the operations further including: in response to determining to process the second candidate SCC set, sending a response message to the second UE accepting the second candidate SCC set.

Example 14 is the one or more processors of Example 9, the operations further including: in response to determining to process the first candidate SCC set, receiving a response message from the second UE accepting the first candidate SCC set.

Example 15 is the one or more processors of Example 5, the operations further including: generating a SCC message for activating or deactivating a first SCC in the candidate SCC set; and sending the SCC message to the second UE.

Example 16 is the one or more processors of Example 15, where generating the SCC message is performed responsive to determining that the first UE is a primary UE and the second UE is a secondary UE.

Example 17 is the one or more processors of Example 15, the operations further including: starting a timer after sending the SCC message to the second UE; receiving a response from the second UE within a pre-configured timer period; and responsive to receiving the response, stopping the timer.

Example 18 is the one or more processors of Example 15, where the SCC message further comprises a tie-breaker value.

Example 19 is the one or more processors of Example 5, the operations further including: designating, from the candidate SCC set, at least one SCC for the carrier aggregation in a specific sidelink signaling radio bearer (SL-SRB); and including in the reconfiguration message an indication of the specific SL-SRB.

Example 20 may include a non-transitory computer storage medium encoded with instructions that, when executed by one or more computers, cause the one or more computers to perform the operations of any of Examples 1 to 19.

Example 21 may include a system including one or more computers and one or more storage devices on which are stored instructions that are operable, when executed by the one or more computers, to cause the one or more computers to perform the operations of any of Examples 1 to 19.

Example 22 may include a method for performing the operations of any of Examples 1 to 19.

Example 23 may include an apparatus including logic, modules, or circuitry to perform one or more elements of the operations described in or related to any of Examples 1-19, or any other operations or process described herein.

Example 24 may include a method, technique, or process as described in or related to the operations of any of Examples 1-19, or portions or parts thereof.

Example 25 may include an apparatus, e.g., a user equipment, including: one or more processors and one or more computer-readable media including instructions that, when executed by the one or more processors, cause the one or more processors to perform the method, techniques, or process as described in or related to the operations of any of Examples 1-19, or portions thereof.

Example 26 may include a computer program including instructions, where execution of the program by a processing element is to cause the processing element to carry out the method, techniques, or process as described in or related to the operations of any of Examples 1-19, or portions thereof. The operations or actions performed by the instructions executed by the processing element can include the operations of any one of Examples 1-19.

Example 27 may include a method of communicating in a wireless network as shown and described herein.

Example 28 may include a system for providing wireless communication as shown and described herein. The operations or actions performed by the system can include the operations of any one of Examples 1-19.

Example 29 may include a device for providing wireless communication as shown and described herein. The operations or actions performed by the device can include the operations of any one of Examples 1-19.

The previously-described operations of Examples 1-19 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors of a first user equipment (UE), the one or more processors configured to cause the first UE to perform operations comprising:
determining a primary component carrier (PCC) for use in carrier aggregation over a sidelink interface with a second UE, wherein the PCC is used at least for control signaling; and
communicating with the second UE via the primary component carrier.

2. The one or more processors of claim 1, the operations further comprising:
receiving, from a base station, a sidelink carrier aggregation configuration that includes an indication of the PCC.

3. The one or more processors of claim 2, wherein the sidelink carrier aggregation configuration further includes a configured component carrier set.

4. The one or more processors of claim 1, wherein communicating with the second UE via the PCC involves initiating a capability exchange procedure with the second UE to determine that the second UE is capable of sidelink carrier aggregation.

5. The one or more processors of claim 1, the operations further comprising:
generating a candidate secondary component carrier (SCC) set that includes one or more SCCs selected from a configured component carrier set for use in the sidelink interface with the second UE; and
sending the second UE a reconfiguration message that includes the candidate SCC set.

6. The one or more processors of claim 5, wherein sending the second UE the reconfiguration message comprises sending the second UE the reconfiguration message via the PCC.

7. The one or more processors of claim 5, the operations further comprising:
receiving, from the second UE, a response message accepting or rejecting the candidate SCC set.

8. The one or more processors of claim 7, wherein the response message rejects the candidate SCC set, and wherein the response message further comprises a rejection cause.

9. The one or more processors of claim 5, wherein the candidate SCC is a first candidate SCC set and the reconfiguration message is a first reconfiguration message, and the operations further comprising:
receiving, from the second UE, a second reconfiguration message that includes a second candidate SCC set; and
determining whether to process the first candidate SCC set or the second candidate SCC set.

10. The one or more processors of claim 9, wherein determining whether to process the first candidate SCC set or the second candidate SCC set is based on a comparison of a first source ID of the first UE and a second source ID of the second UE.

11. The one or more processors of claim 9, wherein determining whether to process the first candidate SCC set or the second candidate SCC set is based on a comparison of: (i) a first tie-breaker value included in the first reconfiguration message, and (ii) a second tie-breaker value included in the second reconfiguration message.

12. The one or more processors of claim 11, wherein the first and second tie-breaker values are based on a randomly selected number or a timestamp.

13. The one or more processors of claim 9, the operations further comprising:
in response to determining to process the second candidate SCC set, sending a response message to the second UE accepting the second candidate SCC set.

14. The one or more processors of claim 9, the operations further including:
in response to determining to process the first candidate SCC set, receiving a response message from the second UE accepting the first candidate SCC set.

15. The one or more processors of claim 5, the operations further including:
generating a SCC message for activating or deactivating a first SCC in the candidate SCC set; and
sending the SCC message to the second UE.

16. The one or more processors of claim 15, wherein generating the SCC message is performed responsive to determining that the first UE is a primary UE and the second UE is a secondary UE.

17. The one or more processors of claim 15, the operations further comprising:
starting a timer after sending the SCC message to the second UE;
receiving a response from the second UE within a pre-configured timer period; and
responsive to receiving the response, stopping the timer.

18. The one or more processors of claim 15, wherein the SCC message further comprises a tie-breaker value.

19-22. (canceled)

23. A method comprising:
determining, by a first user equipment (UE), a primary component carrier (PCC) for use in carrier aggregation over a sidelink interface with a second UE, wherein the PCC is used at least for control signaling; and
communicating with the second UE via the primary component carrier.

24. A first user equipment comprising:
a memory;
a transceiver; and
a processor coupled to the memory and configured to, when executing instructions stored in the memory, cause the first UE to:
determining a primary component carrier (PCC) for use in carrier aggregation over a sidelink interface with a second UE, wherein the PCC is used at least for control signaling; and
communicating with the second UE via the primary component carrier.
